(19) United States
(12) Patent Application Publication
(10) Pub. No.: US 2009/0138330 A1
(43) Pub. Date: May 28, 2009

(54) Time-Varying Media Object Sponsorship

(75) Inventor: Christopher William Higgins, Portland, OR (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 11/946,498

(22) Filed: Nov. 28, 2007

(51) Int. Cl. G06Q 30/00

(52) U.S. Cl. 705/10

(57) ABSTRACT

A service provider facilitates contractual sponsorship of media objects on an interactive network, by monitoring market activity and media object related reactions, and providing time-varying estimates of media object market value and advertising utility value. The service provider determines the best market-supported transactions for both media object owner and sponsor, and neutrally arbitrates between competing interests.

### TECHNICAL FIELD

The present disclosure relates generally to a system to create time-varying contractual relationships for advertising sponsorship of media objects over an interactive network.

### BACKGROUND

As means of communication improve, users of communication devices have an increased ability to consume, generate, and disseminate information, and to interact over the network through the sharing of information. In recent years, the emphasis of users of the Internet has shifted from consumption of content created by large entities, to creation and dissemination of user-generated content. Today, popular and prolific websites like YouTube (xxx/zpvuvcf/dpn) offer users the ability to view, host, and broadcast user-generated multimedia content, such as digital home videos.

The digital information consumer perceives information conveyed over the network through various forms of media objects, including text, icons, voice, audio recordings, pictures, animations, videos, interactive widgets, and other audiovisual information. Descriptions of one or more forms of media objects may be combined in a data object, which the consumer accesses over the network. The data object may contain additional “metadata” information which is not typically observed by the consumer, but may instead define parameters useful in conveying information to the consumer, such as user identifiers, data locaters, data types, or data interpretation resources, as described below. Meta data may combine one of more specialized categories of metadata, such as a “meta identifier”, a “meta keyword”, a “meta URL”, and so on.

Network users typically operate a physical device, such as a telephone, a text messenger, a cell phone, a smart phone, a personal digital assistant, a networked music/video player, a personal computer, or a public terminal, to interconnect with other users on the network. The network user typically utilizes a number of application programs to create or consume content on the network. Example application programs include a “media object player” and a “browser”.

A browser is an application program that is generally intended to display “web pages.” A web page is typically a two-dimensional image appearing as an individual page of information including one or more types of contained media objects. Multimedia content on the network appears in a virtual book format, which typically is displayed as an individually framed “web page” along with means for navigating to other related web pages. A web page may also be associated with consumer perceived audio output. Data for web pages is often described in a format known as a Document Object Model (DOM).

Multimedia content may be directly perceived on a web page or may be indirectly accessible. Content on the page may be directly perceived by including displayed images, videos, or a media object player rendered within the image of the page. Examples of indirect access include access to an audio recording through background music, access through an auxiliary page or pop-up window, access through an auxiliary program, such as the Windows Media Player® available from Microsoft Corp. of Redmond, Wash. or the Apple QuickTime® player available from Apple Computer of Cupertino, Calif., or access provided through a link to another page.

A network user may also become a composer to create new media objects or whole web pages. The DOM for a web page is typically stored in a data file using a common programming language, such as Hyper Text Markup Language (HTML) or Extensible Markup Language (XML). The composer may compose the web page directly by creating a description in the common programming language, or may compose the web page indirectly using an application program to combine text descriptions and other media into a page description in HTML or another suitable language. HTML uses a number of standard definitions referred to as “tags,” whereas XML is classified as an extensible language because it allows its users to define their own tags. XML has been extended by adding semantic constraints to further implement application languages including XHTML, RSS, MathML, GraphML, Scalable Vector Graphics, MusicXML and many others. RSS is a family of web stream formats used to publish content that needs to be updated frequently, such as a video stream or a podcast, and includes the Really Simple Syndication (RSS 2.0), the RDF Site Summary (RSS 1.0 and RSS 0.90), and the Rich Site Summary (RSS 0.91) formats. Potentially valuable web content is developed daily on a massive scale by millions of publishing content creators.

The source code for a media object or a web page may also contain one or more instances of script languages. ECMAScript is a script programming language, standardized by Ecma International of Geneva, Switzerland, in the ECMA-262 specification. JavaScript and Jscript are the most common implementations of the EMCAScript standard. “JavaScript” is a registered trademark of Sun Microsystems, Inc. of Santa Clara, Calif.; technology is further developed and implemented under license by the Mozilla Foundation of Mountain View, Calif. “JScript” is an ECMAScript implementation from Microsoft, Corporation of Redmond, Wash. JavaScript and Jscript are often used for client-side interactive web applications.

When a consumer accesses a web page, script functions can interact with the Document Object Model (DOM) of the web page to perform one or more tasks. Scripts may also be used to make service requests to remote servers after a page has loaded. These requests can obtain new information or data, as well as load or launch additional applications, e.g., media object players, content viewers, application plug-ins, or software codes. Script code can merge with the DOM of the underlying page so that one or more additional media objects are displayed or otherwise rendered on the page. Alternatively, the script code may initiate one or more additional pages or other rendering for the additional media object(s). When script code is embedded into an HTML document and subsequently accessed by a client application, the client application may retrieve and execute the script. The script, optionally using the parameter values in the embed code, may initiate service requests to one or more remote servers to retrieve and render one or more media objects that enhance the underlying content of the page. For example, the script, when executed, may access stored locally stored user preferences or user attributes stored in relation to the use of browser “cookies” and contain one or more user attributes in a dynamically generated service request.

When a media object is published on the network, scripts may be inserted in tags within the media object or within the published web page, and invoked when a consuming user accesses the web page or clicks on a link in the page. For example, a media object may be displayed in physical proximity with related advertising. The tags may additionally allow for various functions to be executed in association with the consumption of the advertising. For example, an Internet service provider may use embedded tags to track the number of reactions of the consumer to the advertising associated with the media object. As known in the art, various advertising reactions may be categorized as impressions, follow-on clicks, or as follow-on actions. Typically, an advertising impression is defined as a consumer viewing the advertisement displayed along with the media object, a follow-on click is defined as a consumer clicking on a link to access another website related to the advertisement, and a follow-on action is defined as an action to facilitate a commercial transaction related to the advertisement, such as placing an online order for advertised goods at a linked website.

FIG. 1 is an illustration of the graphed hypothetical response of an advertisement associated with a media object published on the web. The three categories of consumer responses are depicted as three curves which display quantity as a function of time. The uppermost curve, denoted “views,” graphs the number of consumers who observe an impression of the advertisement. The number of impressions is time-varying, growing from 125 on the first day to 975 on the tenth day. Similarly, the number of follow-on clicks and follow-on actions are also time-varying, with the number of clicks growing from 75 to 550, and the number of actions growing from 25 to 200.

Common payment models for web advertising pay for various combinations of user reactions using a cost per impression (CPM), a cost per follow-on click (CPC), and/or a cost per follow-on action (CPA) model. For example, a first hypothetical payment plan, P1, might require the advertiser to pay for impressions, clicks, and actions at rates with CPM equal to $0.10, CPC equal to $0.37, and CPA equal to $0.85. A second hypothetical payment plan, P2, might require advertisers to pay only for clicks and actions, with CPM equal to $0.00, CPC equal to $0.45, and CPA equal to $1.25. The various rates may depend on some characteristics which are fixed, such as the size of the media object, the size of the advertisement, the publisher of the web page, and so on. Other characteristics affecting the advertising rates may be time-varying, such as the current tier of popularity of the media object, the number and kinds of reactions that it generates, and the demographic groups it attracts. There is a need in the art to better utilize the advertising reactions of media objects, and to improve the tracking of advertising costs to better capture the time-varying value of sponsorship.

The media object rights owner desires to maximize the payments associated with use of the media object. Otherwise unconstrained, the media object rights owner prefers to select a payment plan with maximizes income as a function of time. A further goal of the present invention is to provide a means for the media object rights owner to maximize income as a function of time.

The advertiser may have differing goals. Whereas a media object owner may want to collect full market value of all reactions, some advertisers highly value certain reactions, and devalue other reactions. Further, the advertiser desires to minimize advertising costs. A further goal of the present invention is to provide a means for the advertiser owner to maximize advertising utility for minimum cost as a function of time.

Ultimately, the goals of the media object owner and advertiser may be in conflict. There is a need in the art for a means to neutrally arbitrate these competing interests to facilitate more sponsorship transactions. Further, the nature of markets is time-varying, with markets at times favoring the advertiser (a “buyer's market”) and at other times favoring the media object rights owner (a “seller's market”). A further goal of the present invention is to facilitate neutral advertising sponsorship transactions by tracking the time-varying nature of the market.

At this time, there is no simple way to balance time-varying and competing interests to facilitate improved media object sponsorship transactions. As such, there is a need to provide an infrastructure for interactive network tracking of the advertising market, the value of media objects and the value of associated advertising, and to facilitate a plurality of time-varying advertising sponsorship transactions at a speed and scale appropriate for the Internet. A further goal of the present invention is to provide a practical means of capturing the time-varying nature of such transactions.

### SUMMARY

A service provider facilitates contractual sponsorship of media objects on an interactive network. The service provider monitors market activity and media object related reactions, and provides time-varying estimates of media object market value and advertising utility value. The service provider determines the best market-supported transactions for both media object owner and sponsor, and neutrally arbitrates between competing interests.

### BRIEF DESCRIPTION OF THE DRAWINGS

FIG. 1 is an example of a time-varying advertising response.

FIG. 2 illustrates an example server system.

FIG. 3 illustrates a service provider in a network environment.

FIG. 4 is a flowchart for an example one-time sponsorship pricing process determining a transaction between two parties.

FIG. 5 is a flowchart for an example one-time sponsorship pricing process determining a transaction between three or more parties.

FIG. 6 is an example of the sponsorship process embedded in an accounting/scheduling process which tracks a time-varying response.

### DETAILED DESCRIPTION

The following embodiments and aspects thereof are described and illustrated in conjunction with systems, apparatuses and methods meant to be exemplary and illustrative, not limiting in scope. In various embodiments, one or more of the above-described problems have been reduced or eliminated.

The following description sets forth numerous details to provide a thorough understanding of various aspects of the present invention. It will be apparent to those skilled in the art, however, that the present invention may be practiced without these specific details. In other instances, algorithms for processing data and symbolic representations of algorithmic operations are the means used by those skilled in the art to most effectively convey the substance of their work to others skilled in the art. An algorithm, as used herein, is a sequence of operations leading to a desired result, said operations requiring physical manipulations of physical quantities. Usually, though not necessarily, these quantities take the form of a sequence of electrical signals representing binary numbers to be stored, transferred, combined, compared, and otherwise manipulated.

The present invention also relates to apparatus for performing the operations herein. This apparatus may be specially constructed for the required purposes, or it may comprise one or more general-purpose computers selectively activated by one or more computer programs to achieve the required results. Such a computer program may be stored in any suitable computer-readable storage medium. A computer-readable storage medium includes any mechanism for storing or transmitting information in a form that is usable by a machine, such as a general-purpose computer.

The algorithms and displays presented herein are not inherently related to any particular computer or other apparatus. Various general-purpose systems may be used in accordance with the teachings herein, and it may prove expedient to construct more specialized apparatus to perform the algorithm operations. The required structure for a variety of these systems may appear from the description below. In addition, the present invention is not described with reference to any particular programming language. Those skilled in the art will appreciate that a variety of programming languages may be used to implement the teachings of the invention as described herein.

The invention facilitates transactions primarily between two entities, a media object rights owner and a potential sponsor of the media object. Typically, the potential sponsor seeks to display an advertisement in association with, and in near proximity to, the media object. In return, the potential sponsor remits sponsorship fees generated from the advertisement.

A media object conveys information over the network, which can include text, emoticons, icons, voice, audio recordings, photographs, pictures, animations, videos, interactive widgets, and other audiovisual information. A media object may also contain one or more links to other locations on the network. Typically, the media object has a visual display centralized in a user display. The sponsor typically attaches a second media object, referred to hereinafter as the sponsored object, in near proximity to the media object. The sponsored object typically links to a sponsor website.

When a user accesses a web page containing the sponsored media object, typically both the media object and the sponsored object are in plain view and hence capable of making an impression on the user. The sponsor typically designs the sponsored object to make a positive impression on a potential consumer, and to allow for follow-on commercial activity. Various means are known in the art to track the number of users who view a given media object, and to track the various follow-on activities of a user. One such means is through the use of browser “cookies”, which are executable code objects typically containing data related to the user. Typically, a browser cookie identifies one or more attributes of the user, and can be used to monitor such information as the URLs of websites visited by the user, links that are followed by the user, online orders placed by the user, and so on. A second such means it through the use of other executable code objects embedded in the media object.

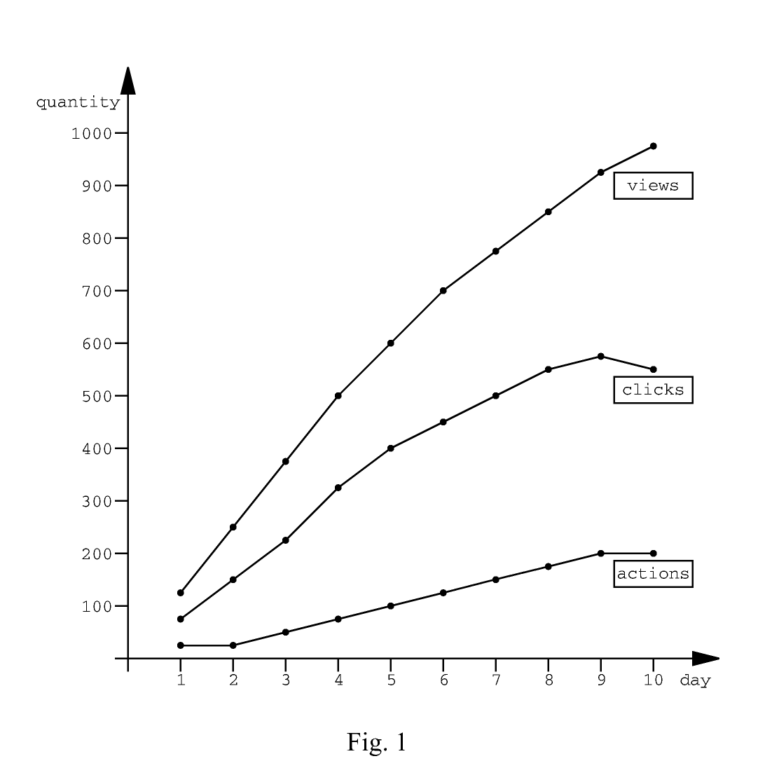

FIG. 1 is an illustration of the graphed hypothetical response to a sponsored object associated with a media object published on the web. In a preferred embodiment, a media object tracking function determines the number of various user actions related to the sponsored object per unit of time. Three such actions are shown, as three separate curves representing the number of impressions, the number of follow-on links from the sponsored object, and the number of follow on actions. For illustrative purposes only and not by way of limitation, a follow-on action may consist of requesting further information or placing an order on the sponsor's website.

As shown in FIG. 1, statistics are accumulated over a measurement period, here illustrated as collected on a daily basis, for the first ten days after the sponsored media object is published. A sponsored media object typically generates a response which can vary significantly over time. The time varying response may be modeled by piecewise linear curves as shown in FIG. 1, or may be approximated by other curve-fitting algorithms. A primary object of the current invention is to process the time-varying statistical performance to determine a fair market value sponsorship deal for an upcoming measurement period.

The time-varying response is divided into measurement periods whose span is relatively short compared to the overall response, and, in a preferred embodiment, statistics are collected in each measurement period. Although the measurement period illustrated in FIG. 1 is one day, other measurement periods are possible.

The response may be further categorized by comparing the response per unit time to various thresholds. For example, a sponsored media object with 1000 or fewer impressions in the latest measurement period might be considered an object of low interest, a sponsored media object with 1000 to 10,000 impressions in the latest measurement period might be considered an object of moderate interest, and a sponsored media object with more than 10,000 impressions in the latest measurement period might be considered a blockbuster hit. Although the example contains three tiers, any number of tiers and any of various thresholds are possible. In one embodiment, a potential sponsor pays differing amounts depending on a tiered level of response.

Further, a system provider may further categorize the response to the media object by collecting statistics related to the attributes of demographics of consumers. For example, a service provider may explicitly request or otherwise obtain the age of each user, and be able to determine the statistical response of the sponsored media object for consumers in various age ranges. An advertiser of products for seniors, for example, may desire to sponsor media objects with appeal to those over the age of fifty. The service provider may further statistically determine various other attributes of consumers of a sponsored media object, such as the ethnicity of consumers, the sex of consumers, homeownership status, income level, and so on. In one embodiment, a potential sponsor pays differing amounts depending on the actual statistical characteristics of the consumer actions producing the pricing event.

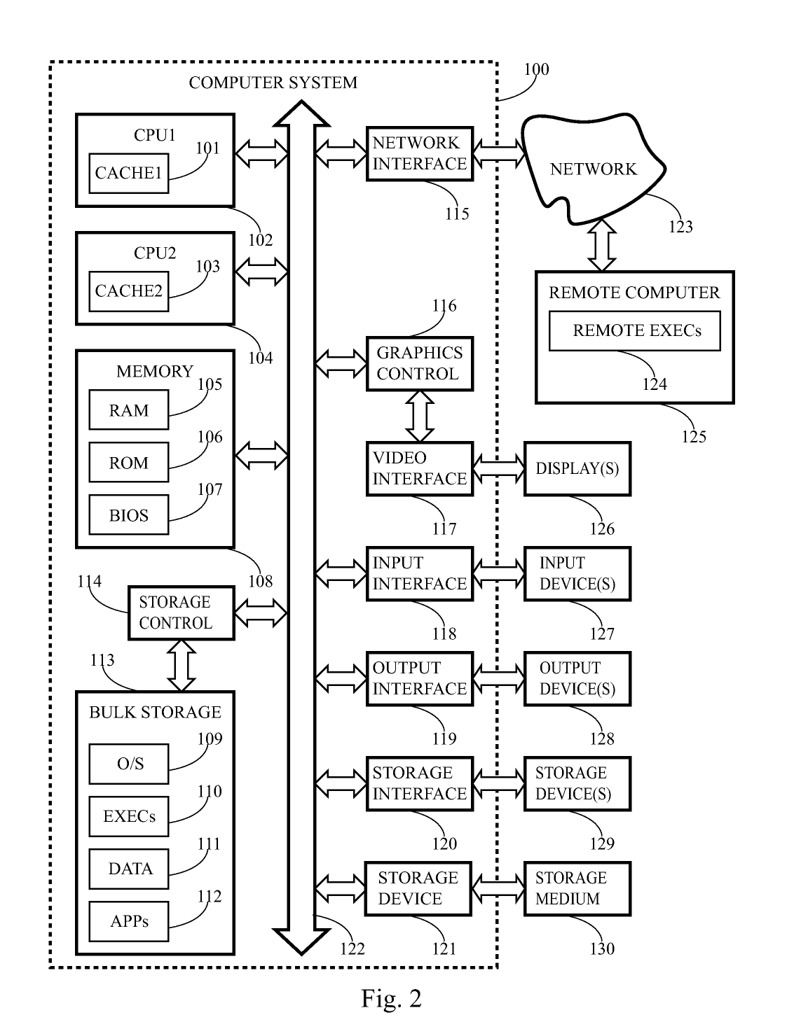

Server and client systems are used to categorize the response of media objects and facilitate the transactions. Server and client systems described herein can be implemented by a variety of computer systems and architectures. FIG. 2 illustrates suitable components in an exemplary embodiment of a general-purpose computer system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computer system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 2, an exemplary system for implementing the invention may include a general-purpose computer system 100. Computer system 100 accesses one or more applications and peripheral drivers directed to a number of functions described herein. Components of the computer system 100 may include, but are not limited to, a CPU or central processing unit 102, a system memory 108, and a system bus 122 that couples various system components including the system memory 108 to the processing unit 102. As used by those skilled in the art, a signal “bus” refers to a plurality of digital signal lines serving a common function. The system bus 122 may be any of several types of bus structures including a memory bus, a peripheral bus, and a local bus using any of a variety of bus architectures. By way of example, and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

An operating system manages the operation of computer system 100, including the input and output of data to and from applications (not shown). The operating system provides an interface between the applications being executed on the system and the components of the system. According to one embodiment of the present invention, the operating system is a Windows® 95/98/NT/XP/Vista/Mobile operating system, available from Microsoft Corporation of Redmond, Wash. However, the present invention may be used with other suitable operating systems, such as an OS-X® operating system, available from Apple Computer Inc. of Cupertino, Calif., a UNIX® operating system, or a LINUX operating system.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, random access memory (RAM), read-only memory (ROM), electrically erasable programmable ROM (EEPROM), flash memory or other memory technology, compact-disk ROM (CD-ROM), digital versatile disks (DVD) or other optical disk storage, magnetic tape cassettes, magnetic tape, hard magnetic disk storage or other magnetic storage devices, floppy disk storage devices, magnetic diskettes, or any other medium which can be used to store the desired information and which can accessed by the computer system 100.

Communication media may also embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared, cellular networks, and other wireless media.

The system memory 108 includes computer storage media in the form of volatile and/or nonvolatile memory such as read only memory (ROM) 106 and random access memory (RAM) 105. A basic input/output system 107 (BIOS), containing the basic routines that help to transfer information between elements within computer system 100, such as during start-up, is typically stored in ROM 106 and other non-volatile storage, such as flash memory. Additionally, system memory 108 may contain some or all of the operating system 109, the application programs 112, other executable code 110 and program data 111. Memory 108 typically contains data and/or program modules that are immediately accessible to and/or presently being operated on by CPU 102. Optionally, a CPU may contain a cache memory unit 101 for temporary local storage of instructions, data, or computer addresses.

The computer system 100 may also include other removable/non-removable, volatile/nonvolatile computer storage media. By way of example only, FIG. 2 illustrates a bulk storage 113 that reads from or writes to one or more magnetic disk drives of non-removable, nonvolatile magnetic media, and storage device 121 that may be an optical disk drive or a magnetic disk drive that reads from or writes to a removable, a nonvolatile storage medium 130 such as an optical disk or a magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. Bulk storage 113 and the storage device 121 may be connected directly to the system bus 122, or alternatively may be connected through an interface such as storage controller 114 shown for bulk storage 113. Storage devices may interface to computer system 100 through a general computer bus such as 122, or may interconnect with a storage controller over a storage-optimized bus, such as the Small Computer System Interface (SCSI) bus, the ANSI ATA/ATAPI bus, the Ultra ATA bus, the FireWire (IEEE 1394) bus, or the Serial ATA (SATA) bus.

The storage devices and their associated computer storage media, discussed above and illustrated in FIG. 2, provide storage of computer-readable instructions, executable code, data structures, program modules and other data for the computer system 100. For example, bulk storage 113 is illustrated as storing operating system 109, application programs 112, other executable code 110 and program data 111. As mentioned previously, data and computer instructions in 113 may be transferred to system memory 108 to facilitate immediate CPU access from processor 102. Alternatively, processor 102 may access stored instructions and data by interacting directly with bulk storage 113. Furthermore, bulk storage may be alternatively provided by a network-attached storage device (not shown), which is accessed through a network interface 115.

A user may enter commands and information into the computer system 100 through the network interface 115 or through an input device 127 such as a keyboard, a pointing device commonly referred to as a mouse, a trackball, a touch pad tablet, a controller, an electronic digitizer, a microphone, an audio input interface, or a video input interface. Other input devices may include a joystick, game pad, satellite dish, scanner, and so forth. These and other input devices are often connected to CPU 102 through an input interface 118 that is coupled to the system bus, but may be connected by other interface and bus structures, such as a parallel port, a game port or a universal serial bus (USB). A display 126 or other type of video device may also be connected to the system bus 122 via an interface, such as a graphics controller 116 and a video interface 117. In addition, an output device 128, such as headphones, speakers, or a printer, may be connected to the system bus 122 through an output interface 119 or the like.

The computer system 100 may operate in a networked environment using a network 123 to one or more remote computers, such as a remote computer 125. The remote computer 125 may be a terminal, a personal computer, a server, a router, a network PC, a peer device or other common network node, and typically includes many or all of the elements described above relative to the computer system 100. The network 123 depicted in FIG. 2 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 2 illustrates remote executable code 124 as residing on remote computer 125. It will be appreciated that the network connections shown are exemplary and other means of establishing a communications link between the computers may be used.

Collectively, these elements are intended to represent a broad category of computer systems, including but not limited to general purpose computer systems based on one or more members of the family of CPUs manufactured by Intel Corporation of Santa Clara, Calif., the family of CPUs manufactured by Advanced Micro Devices (AMD), Inc., of Sunnyvale, Calif., or the family of ARM CPUs, originally designed by Advanced RISC Machines, Ltd., as well as any other suitable processor. Of course, other implementations are possible. For example, the server functionalities described herein may be implemented by a plurality of server sub-systems communicating over a backplane.

Various components of computer system 100 may be rearranged, deleted, or augmented. For example, system bus 122 may be implemented as a plurality of busses interconnecting various subsystems of the computer system. Furthermore, computer system 100 may contain additional signal busses or interconnections between existing components, such as by adding a direct memory access unit (not shown) to allow one or more components to more efficiently access system memory 108.

As shown, CACHE1 and CPU1 are packed together as “processor module” 102 with processor CPU1 referred to as the “processor core.” Alternatively, cache memories 101, 103, contained in 102, 104 may be separate components on the system bus. Furthermore, certain embodiments of the present invention may not require nor include all of the above components. For example, some embodiments may include a smaller number of CPUs, a smaller number of network ports, a smaller number of storage devices, or a smaller number of input-output interfaces. Furthermore, computer system 100 may include additional components, such as one or more additional central processing units, such as 104, storage devices, memories, or interfaces. In addition, one or more components of computer system 100 may be combined into a specialized system-on-a-chip (SOC) to further system integration. In some computer system environments where component count is critical, the entire computer system may be integrated in one or more very large scale integrated (VLSI) circuit(s).

As discussed below, in one implementation, operations of one or more of the physical server or client systems described herein is implemented as a series of software routines executed by computer system 100. Each of the software routines comprises a plurality or series of machine instructions to be executed by one or more components in the computer system, such as CPU 102. Initially, the series of instructions may be stored on a storage device, such as bulk storage 113. However, the series of instructions may be stored in an EEPROM, a flash device, or a DVD. Furthermore, the series of instructions need not be stored locally, and could be received from a remote computer 125 or a server on a network, via network interface 115.

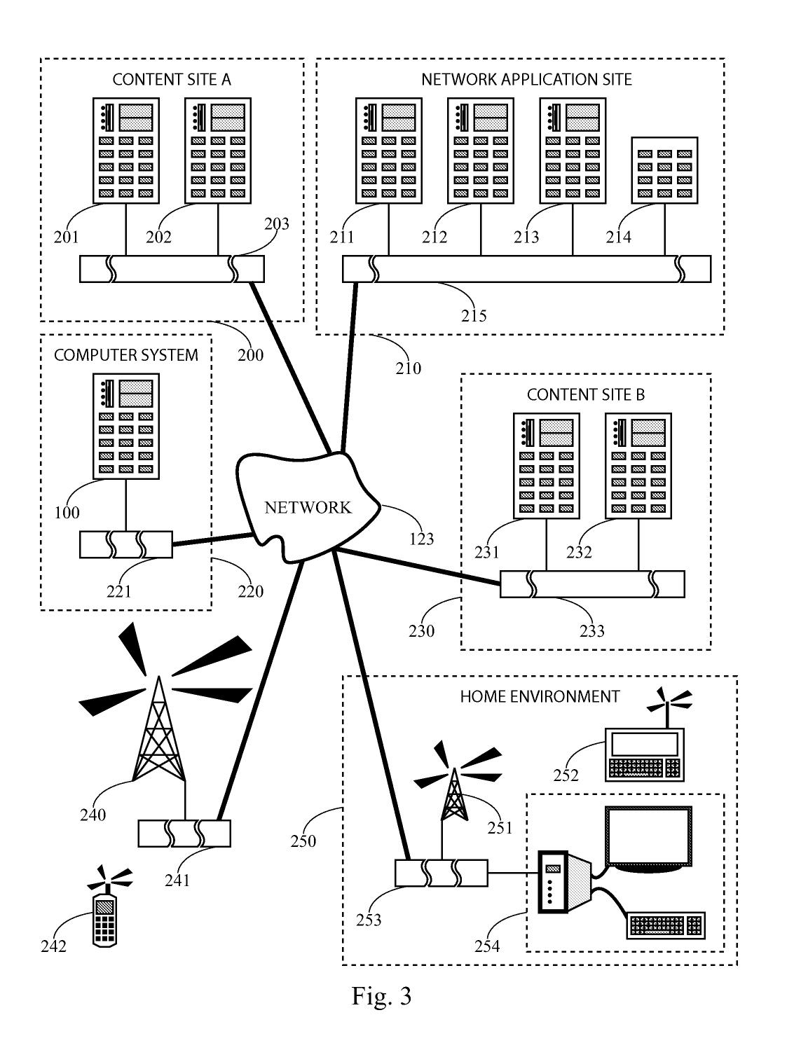

FIG. 3 illustrates computer system 100 placed in an example wide area network environment, such as the Internet. Network cloud 123 generally represents one or more interconnected networks, connecting computer system 100, a plurality of network sites, 200, 210, 220, 230, 240, and 250, and a plurality of client devices, 242, 251, 252, and 254. Network cloud 123 may include TCP/IP based wide area networks, private networks, wireless networks, satellite networks, cellular networks, paging networks, and the like. Client systems, such as portable device 242, portable computer 252, and personal computer 254 are operably connected to the wide area network environment through an internet service provider (not shown), a cellular provider 240, a wireless provider (not shown), a local wireless network 251, and/or a local wired network 253.

Computer system 100 is contained within the network site 220, where one or more computer systems, such as computer system 100, are connected to a local area network and router 221. The router 221 manages local computer communication traffic in network site 220 and interconnects with network cloud 123. Router 221 also functions to translate one or more local area network addresses in network site 220 to provide one or more unique corresponding wide area network addresses in order to facilitate communication between computer systems in network site 220 and other computer systems on the wide area network.

FIG. 3 illustrates a number of network service provider sites, including content site A 200, content site B 230, and network application site 210. The described invention may operate with one or more content providing or application sites. Although FIG. 3 illustrates the provider sites as separate local network sites, the functionality of each site may be combined with other sites. Further, a function for a particular site may be performed in a distributed computing environment by one or more computer systems at remote sites. Further still, the functionality represented by each depicted site may be further separated into a plurality of sub-function sites. In addition, implementations of the invention may operate in network environments that include multiples of one or more of the individual sites or subsystems of sites described herein. Implementations of the invention may also operate in network environments where one of more of the systems or sites described herein has been eliminated.

Content aggregation sites are represented by content site A 200 and content site B 230 in FIG. 3. Content is stored as one or more digital data objects. A digital data object may include one or more media objects or executable code objects. Content site A 200 is a network addressable system that allows users to access media objects supplied by one or more users. In one implementation, content site A 200 may be a media object aggregation or sharing system, such as the Yahoo! Geocities® blog-sharing site, and similar variants. Content site A 200 comprises one or more physical server systems 201, 202, implemented using an architecture such as that of computer system 100, and containing or connected to one or more bulk storage systems, such as that of bulk storage system 113, or a network attached storage device (not shown), and a local area network and router 203. The one or more physical servers allow users to upload and download media objects. In one implementation, the functionality hosted by the one or more physical servers may include web or HTTP servers, FTP servers, and the like.

Content site B 230 is a network addressable system that allows users to access content supplied by one of more content suppliers (not shown). Content site B 230 comprises one or more physical server systems 231, 232 containing or connected to one or more bulk storage systems (not shown), and a local area network and router 233. The one or more physical servers 231, 232 allow the service provider (not shown) to store media objects and users to download media objects.

Network application site 210 is a network addressable system that allows users to access one or more executable code objects supplied by one or more service providers (not shown). Network application site 210 comprises one or more physical server systems 211, 212, 213 containing or connected to one or more bulk storage systems, shown as network-attached storage device 214, and a local area network and router 215. Executable code objects may include code to be executed on a client device as well as code executed within a server system, such as server 212. An example of an executable code object is an informational web site where users request and receive identified web pages and other content over the network cloud 123. The executable code object may also be a posting forum, where users may submit or otherwise configure media objects to be perceived by other users. The executable code object may also be a social network application, such as a chat client or e-mail client, adapted to establish intermediated or peer-to-peer communications with other clients. The executable code object may also be a web-posting application, allowing users to configure and maintain personal web pages. One or more executable code objects may also combine to form a content distribution application that displays available media objects and transmits them to users. Examples of network application sites include Yahoo! Music Engine®, Apple iTunes®, and podcasting servers.

Network application site 210 also represents a suitable architecture for a site devoted to applicant's invention, in which server 211 may operate as a media object tracking server, server 212 may operate as a market tracking server, and server 213 may operate as a transaction server, as explained further below.

In the context of a computer network, a “virtual server” is physically one or more server systems connected to the network and support circuitry to execute application programs for processing data. Data may be stored by means which facilitate efficient processing, such as by storing the data in a “database” consisting of a collection of data organized by relationships between the various forms of data contained therein. When a virtual server consists of more than one computer server system, the set of computer server systems is interconnected hierarchically to perform high-level functions as combined functions of several servers under central control.

Functionally, a virtual server executes a sequence of low-level CPU commands to complete instructions for processing data. A virtual server typically accepts instructions and executes commands for a multitude of “clients”. The instructions may include, but are not limited to, instructions to store or retrieve data, to modify, verify or erase data, or to reorganize data. A virtual server may also initiate instructions for other network-attached devices. For example, a virtual “music server” might maintain a database to locate a library of musical compositions. The music server might receive commands to store new songs or retrieve old ones from a number of clients. Further, the music server might send commands to other devices on the network, e.g., to disseminate the musical database among various subservient servers, such as a “jazz server,” a “hip-hop server,” a “classical server,” and so on, to register paying user requests in a “billing server,” to verify the identity, preferences, and access privileges of a user in a “registration server” and so on. The music server may therefore also be a client of other servers. Practitioners of the art will recognize that virtual servers and clients are abstract interactive devices controlled by software instructions, whose interaction protocols may be flexibly defined. A “client” as used herein may include functionally to process information and programs, as well as to issue commands. Similarly, a virtual server as used herein may include functionally to initiate commands to users and other servers as well as to respond to instructions.

Similarly, a database should not be construed to be a single physical collection of data. As used herein, a database is an abstract collection of data which may be distributed over one or more physical locations. Said data may be stored physically within a single or multiple servers, within attached physical device(s), network attached device(s), or user devices(s). Similarly, an application program should not be construed to be a single physical collection of commands. As used herein, an application program is an abstract collection of CPU commands, which may be physically executed, in whole or in part, within a single or multiple servers, within attached physical devices(s), within network attached device(s), or within user device(s).

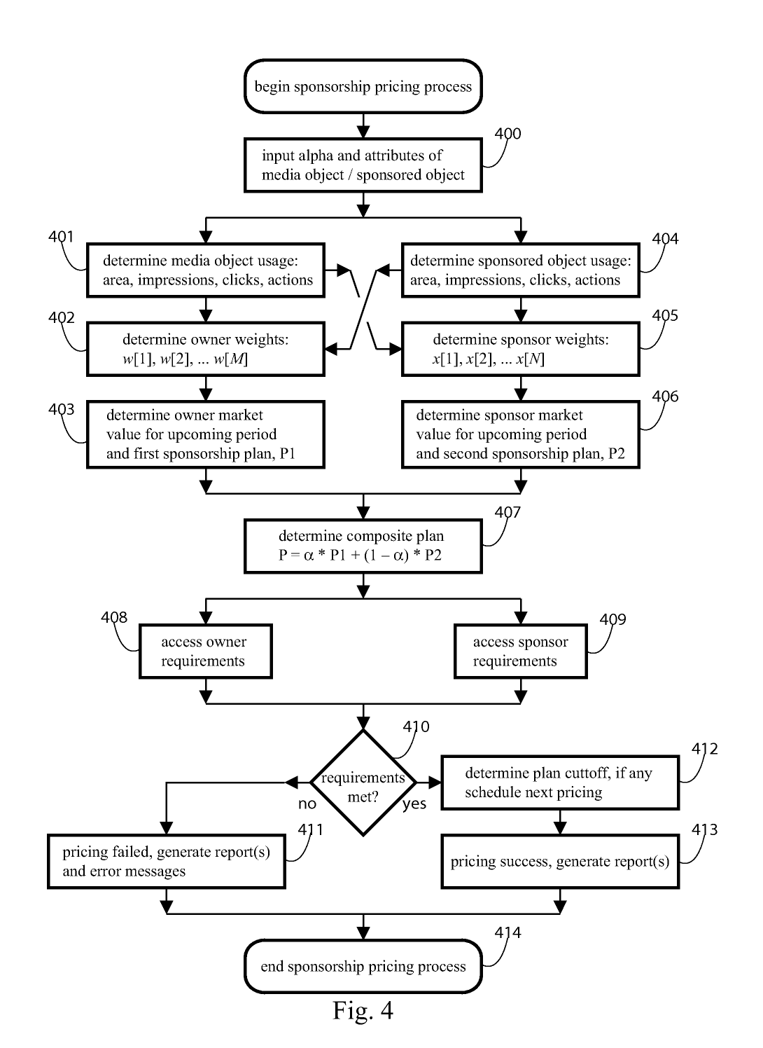

FIG. 4 is a flowchart illustrating an example method for determining terms of an individual sponsorship contract. The example method operates by first determining terms from opposing viewpoints of the buyer and seller, and then combines terms in a composite pricing plan.

In a preferred embodiment, a service provider monitors market conditions for a large number of sponsorship contracts on the network, and compiles composite statistics concerning various common sponsorship plans and rates associated with each plan. For illustration purposes only and not by way of limitation, a simple hypothetical market for sponsorship of media objects is assumed and the method is illustrated with the simple model and extensions.

For illustration purposes, a first simple two-way model considers the transaction at question to primarily consist of a transaction between a media object rights owner (the seller) and a potential sponsor (the buyer). As described further below, alternative embodiments incorporate other parties, improved models, and more secondary considerations. In particular, a three-way model between a media object rights owner, a sponsor, and a publisher of the sponsored media object is also described.

A simple exemplary model for sponsorship of a media object allows sponsorship of any combination of sponsored object impressions, clicks, and follow-on actions. The sponsor pays for each impression at a rate CPM, each click of a sponsored link at a rate CPC, and each follow-on action at a rate CPA. In the simple model, a sponsor may choose one of seven sponsorship plans. The sponsor may (1) remit fees for all three types of responses, or for any two types of responses: {(2) clicks/impressions, (3) clicks/actions, or (4) impressions/actions}, or for any single type of response: {(5) impressions, (6) clicks, or (7) actions}.

The rates, CPM, CPC, and CPA, vary depending on the sponsorship plan. For example, a first sponsorship plan, P[1], may remit fees for all types of responses at rates denoted CPM[1], CPC[1], and CPA[1], with indices to indicate that they are rates associated with plan P[1]. A second sponsorship plan, P[2], may remit fees only for clicks and impressions, with CPA[2] equal to zero. In addition, the rates for clicks and impressions under plan P[2], CPC[2] and CPM[2], respectively, are typically different than the rates CPC[1] and CPM[1].

FIG. 4 is a simplified flowchart representing an example sponsorship pricing process consisting of a number of steps. FIG. 4 assumes that an existing media object is to be mated with an existing sponsored object. Further, it is assumed that the system provider has a media object statistical collection engine that can be accessed to determine one or more attributes of the media object and sponsored object. It is further assumed that the system provider determines a balancing factor, alpha, based on current market conditions, as described further below.

Attributes of the media object and the sponsored object, and the balancing factor alpha are input to the sponsorship pricing process in step 400. Steps 401-403, which determine current market value for the owner of the media object, proceed in parallel with steps 404-406, which determine current sponsorship market value. In step 401, the identification of the media object is used to access collected statistics or otherwise estimate usage of the media object for the next measurement period. Based on observed statistics, the service provider may estimate the number of impressions, clicks, and actions expected for an average attached sponsored object. Various other factors related to the media object may be taken into account. For example, the media object typically uses up a certain portion of the consumer's visual display, and the area of the used portion may be taken into account. The service provider may further provide thresholds to create a plurality of tiers of responses, or may further determine expected demographics of consumers accessing the media object and charge accordingly. The service provider may further account for one or more attributes related to the media object, such as the publishing entity, and may include for example the cost per unit area of display on a publisher's website. As discussed further below, a modified model and algorithm may also adjust a three-way transaction split between an owner, a sponsor, and a publisher.

In step 402, the various usage factors are used to determine a series of weights, w[1], w[2], . . . , w[M] related to the media object, where M is a positive integer. The weights are used to multiply an owner base pricing formula to determine a customized pricing plan for the media object. For example, an owner base pricing formula may determine an owner base price, ownerbase, for some response based on usage of a unit of area in a display screen. The actual area of the displayed media object may, for example, be w[1]. To account for the additional area, a modified base price, ownerbase*w[1], is determined for the media object. The overall pricing formula accounts for all weighting factors, calculated a customized price,

ownerbase*w[1]*w[2]* . . . *w[M].

In a preferred embodiment, a separate set of weighting factors is determined for each type of response and each type of sponsorship plan. The sets of weighting factors are then used to calculate a customized price for each impression, click, or action under each type of sponsorship plan. In step 402, secondary factors, determined in step 404 and explained further below, affect the pricing of media object sponsorship by considering attributes of the sponsored object, such as the area of the sponsored object.

In step 403, the various sponsorship plans are compared to determine a best sponsorship plan for the media object owner. The service provider estimates the number of various responses to the sponsored object, and chooses the plan that maximizes revenue. In FIG. 4, the plan that maximizes revenue over the next measurement period for the media object owner is referred to as a first sponsorship plan, P[1], with associated rates CPM[1], CPC[1], and CPA[1].

Steps 404-406 determine sponsorship market value. In step 404, the various usage factors are used to determine a series of weights, x[1], x[2], . . . , x[N] related to the sponsored object, where N is a positive integer. The weights are used to multiply a sponsor base pricing formula to determine a customized sponsor pricing plan for the sponsored object. For example, a sponsor base pricing formula may determine a sponsor base price, sponsorbase, for some response (e.g. impressions) based on the total expected number of said response (impressions) by all consumers in the upcoming measurement period. The sponsor, on the other hand, may desire to tailor payments to only pay for impressions of consumers within a certain demographic group (e.g. 20 to 30 year old consumers). The service provider may determine a factor x[1] to account for the expected proportion of consumers within the demographic group, where x[1], in one example, is a ratio,

x[1]=(expected total response)/(expected demographic group response),

A modified base price, sponsorbase*x[1], is determined for the sponsored object. The overall pricing formula accounts for all weighting factors, calculated a customized price,

sponsorbase*x[1]*x[2]* . . . *x[N].

In a preferred embodiment, a separate set of weighting factors is determined for each type of response and each type of sponsorship plan. The sets of weighting factors are then used to calculate a customized price for each impression, click, or action under each type of sponsorship plan. In step 405, secondary factors, determined in step 401 and explained further above, affect the pricing of sponsored object sponsorship by considering attributes of the media object, such as the area of the media object, the owner/creator of the media object and historical performance of similar media objects.

In step 406, the various sponsorship plans are compared to determine a best sponsorship plan for the sponsor. The sponsor may further designate a subset of the available plans for active consideration. The sponsor may further designate attributes of a “favorable” response, such as an impression, click or action of a member of a certain demographic group. The service provider estimates the number of various designated favorable responses to the sponsored object, and chooses the plan that maximizes sponsorship value. In FIG. 4, the plan that maximizes sponsorship value over the next measurement period for the sponsor is referred to as a second sponsorship plan, P[2], with associated rates CPM[2], CPC[2], and CPA[2].

In step 407, the two determined sponsorship plans are combined into a composite plan using a weighting factor, alpha. The weighting factor alpha is used to linearly combine the first sponsorship plan, P[1], and the second sponsorship plan P[2], to create a composite plan P, where

P=alpha*P[1]+(1−alpha)*P[2].

The factor alpha accounts for time-varying market conditions which at times favor sellers and at other times favor buyers. For example, when alpha equals one, the market is consider a pure seller's market, and the composite plan is determined to be the plan P[1] which maximizes revenue for the seller. Similarly, when alpha equals zero, the market is considered a pure buyer's market, and the composite plan is determined to be the plan P[2] which maximizes sponsorship utility for the sponsor. Under normal conditions, the market is somewhere between these extremes, with 0<alpha<1. The service provider analyzes statistics for a plurality of current market transactions, and adjusts alpha to account for current market conditions, including the actual popularity of an individual media object or sponsor.

For example, a first determined sponsorship plan, P[1], may remit for responses at rates with CPM[1]=$0.10, CPC[1]=$0.60, and CPA[1]=$1.80. A second determined sponsorship plan, P[2], may remit for responses at rates with CPM[2]=$0.00, CPC[2]=$0.80, and CPA[2]=$2.40. If the service provider utilizes a value of alpha equal to 0.4, the composite sponsorship plan P remits for responses at rates:

CPM=0.4*$0.10+0.6*$0.00=$0.04,

CPC=0.4*$0.60+0.6*$0.80=$0.72, and

CPA=0.4*$1.80+0.6*$2.40=$2.16.

In step 408, estimated revenue for the composite plan is compared to accessed media object owner requirements. In step 409, estimated sponsorship utility is compared to accessed sponsor requirements. In step 410, the results of these comparisons are combined to determine if the requirements of both parties have been met. If so, the parties are assumed to mutually consent to the composite sponsorship plan, and the flow chart proceeds to step 412. If not, various additional remedial steps (not shown) may be optionally included in one embodiment, such as transmitting an alternative compromise offer to one or both of the parties, and awaiting a response prior to step 411. In step 411, it is assumed that the composite pricing plan determined in step 407 has been rejected, and, in the case of an optional compromise offer embodiment, every optional alternative plan has been rejected. Step 411 generates various diagnostic reports and error messages to report the pricing failure.

In step 412, the expected sponsorship fees are compared to limits as set by the sponsor. For example, the sponsor may provide a total advertising budget or a maximum total number of sponsored impressions, clicks, and/or actions. In such a case, the service provider estimates the sponsored object usage and/or the total fees generated, and if necessary, schedules a plan cutoff. For example, a sponsor may specify a sponsorship budget allowing for 900 more impressions. In one embodiment, the service provider invokes a cutoff option to count the number of impressions as they occur, and to end the sponsorship contract when the desired goal is reached. In a further embodiment, the service provider allows a sponsor to specify a maximum sponsorship fee. In one embodiment, the service provider invokes a cutoff option to count the number of paying responses as they occur, and to end the sponsorship contract when the desired maximum sponsorship fee is reached.

In one embodiment, the service provider also estimates if the sponsor's goals will remain unfulfilled at the end of the measurement period. For example, a sponsor may specify a sponsorship budget allowing for 900 more impressions, and the service provider estimates that only 400 more impression responses will occur in the next measurement period. If the service provider estimates that the sponsor's goals will remain unfulfilled, the sponsor may schedule a future pricing process at the end of the current measurement period in step 412. At that time, statistical usage information for both the media object and the sponsored object are updated to reflect current statistics and the time-varying nature of network responses over the most recent measurement period. Although the time-varying response to the sponsored media object shows great variation over the long-term, over relatively shorter terms the variation tends to be reduced and more predictable. The unpredictable long-term time-varying response to the sponsored media object is approximated for a relatively short period consisting of a measurement period, and the estimates are updated using most recent statistics during each measurement period. As such, the time-varying performance of the sponsored media object may be desirably estimated with improved accuracy.

Step 412 proceeds to step 413, where the service provider generates various reports to indicate the pricing process success. The media object owner and the sponsor are notified, and the result of the pricing process is accumulated in the market condition server.

If the sponsor or media object owner has requirements that are not met in step 410, the pricing process failed. Various reports and error messages are generated in step 411, and the market condition server is notified. The sponsorship pricing process ends in step 414.

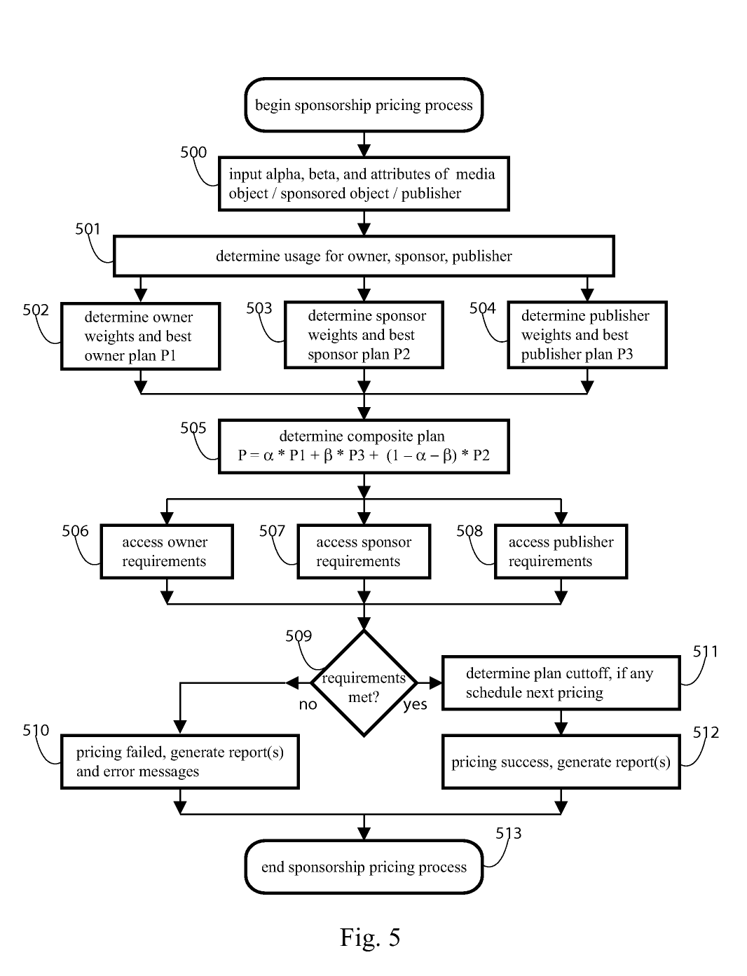

FIG. 5 is a flowchart of a similar sponsorship pricing process when there are three or more major parties to the transaction. As a simple clarifying example and not by way of limitation, in FIG. 5 it is assumed that the three major parties are a media object rights owner, a potential sponsor, and a potential publisher. A differing number of parties to the transaction are possible, and different priorities of the various parties may be implemented. For example, in certain markets the publisher may have significant market power and the publisher's priorities may eclipse those of the owner. As an illustrative example, an online audio provider/publisher such as the Apple iTunes Music Store may have significant market power in determining a publishing deal with a relatively unknown artist.

In FIG. 5, the sponsorship process begins with inputs including attributes of the media object, the sponsored object, and the publisher in step 500. Additionally, the service provider estimates the relative market power of the media object rights owner with a weighting factor alpha, and the relative market power of the publisher with a weighting factor beta. Typically, the factors are such that 0<alpha<1 and 0<beta<1. Similarly, in a transaction with p parties, (p−1) weighting factors may be utilized.

In step 501, the service provider estimates the network consumption and usage for all parties, including in this example usage of the media object, the sponsored object, and the publisher. The usage estimates are used to determine sets of weights for each party; in this case, weights for the media object owner, the potential sponsor, and the publisher are determined in steps 502-504, respectively. The weights are also used to determine a best plan for each of the parties. In step 505, the three plans are combined to form a various parties are compared to the estimated response to the composite sponsorship plan. Step 509 checks to see if all the requirements have been met. If so, a consensual contract has been determined, and steps 511-512 determine a plan cutoff, schedule the next pricing session, and generate reports as in corresponding steps 412-413 of FIG. 4. If all the requirements are not met, step 509 proceeds to step 510 to generate reports and error messages as in corresponding steps 411 of FIG. 4. The sponsorship pricing process terminates in step 513.

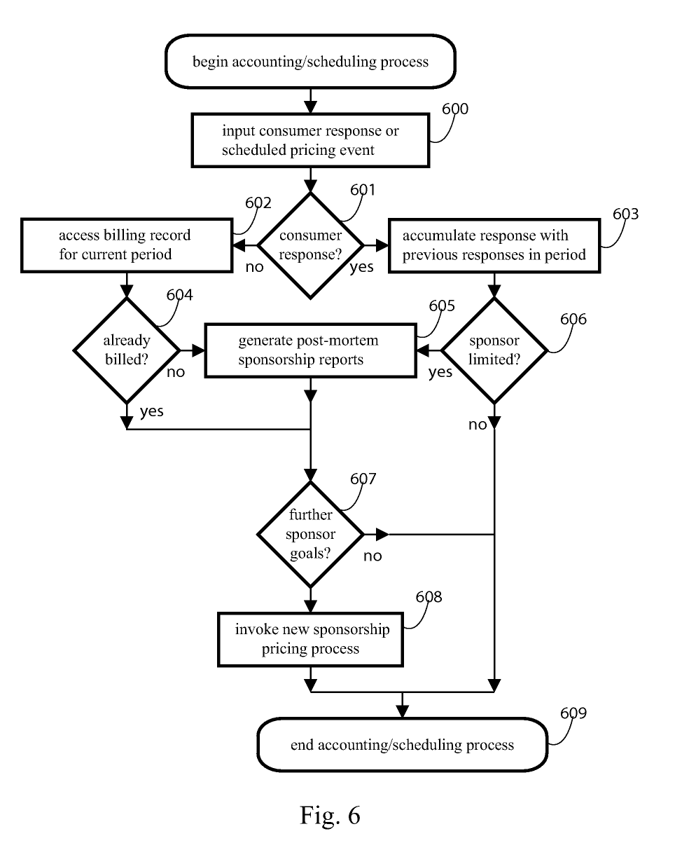

Once a sponsorship plan has been established, the various responses of sponsored media objects in the billing period must be accumulated and billed in an accounting process, and a next sponsorship pricing process may be scheduled. The accounting and scheduling process may be combined in an example accounting/scheduling process shown as a flowchart in FIG. 6.

The process begins in step 600 as a result of a consumer response to the sponsored media object or is invoked when a next scheduled pricing process is set to occur. In step 601, the process checks if it is invoked through a consumer response. If so, step 601 proceeds to step 603, where the consumer response is accumulated with other consumer responses in the billing period. In step 606, the sponsor limits on consumer responses are checked. If the number of responses or the total value of responses exceeds a sponsor limit, the sponsorship plan is complete and the flowchart proceeds to step 605. If a sponsor limit has not been reached in step 606, the accounting process terminates in step 609. If the accounting/scheduling process is not invoked by a consumer response, the process is invoked due to a scheduled pricing event, and step 601 proceeds to step 602. Step 602 checks to see if the current period has already been reconciled, as may occur, for example, when a sponsorship limit has previously been reached. If the period has not already been billed, step 604 proceeds to step 605. Step 605 generates post-mortem billing reports for the billing period. Once a billing report has already been generated, in step 604 or step 605, the flowchart proceeds to step 607. In step 607, the accumulated responses to the sponsored media object are combined and compared to the sponsor goals. If there are remaining sponsorship goals for the media object, a new sponsorship pricing process is invoked in step 608. The accounting/scheduling process terminates in step 609.

In this manner, a sponsorship pricing process may be desirably embedded within an accounting/scheduling process, operating to re-invoke the sponsorship pricing process when a measurement period expires if there are remaining sponsorship goals. All parties benefit from an impartial service provider process which tracks the changing market value of sponsored media objects and arbitrates a fair deal among all participants based upon currently prevailing market conditions.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of determining financial terms of a transaction related to associating a sponsored object with a media object on a network, the method comprising
receiving, from a remote host, a request for financial terms of a sponsorship transaction, wherein the request includes one or more attributes of a media object, a media object rights owner, a potential sponsor, and a potential sponsored object;
analyzing sponsorship market activity to determine a set of potential sponsorship transaction structures;
analyzing media object and sponsored object response activity to determine expected consumer responses to the media object and the sponsored object;
determining a best owner transaction structure and associated market value for the media object rights owner;
determining a best sponsor transaction structure and associated market value for the sponsor;
combining said best owner and sponsor transaction structures into a composite transaction structure with a fee schedule providing for remission of fees for one or more responses to the sponsored media object; and
transmitting, to the remote host, the composite transaction structure and fee schedule.

2. The method of claim 1, wherein the potential sponsorship transaction structures include two or more of the following seven structures:
(1) a payment per impression at a rate CPM, a payment per activation of a sponsored link at a rate CPC, and a payment per sponsored follow-on action at a rate CPA;
(2) a payment per impression at a rate CPM, and a payment per activation of a sponsored link at a rate CPC;
(3) a payment per impression at a rate CPM and a payment per sponsored follow-on action at a rate CPA;
(4) a payment per activation of a sponsored link at a rate CPC and a payment per sponsored follow-on action at a rate CPA;
(5) a payment per impression at a rate CPM;
(6) a payment per activation of a sponsored link at a rate CPC; and
(7) a payment per sponsored follow-on action at a rate CPA.

3. The method of claim 1, wherein the determining a best owner transaction structure and associated market value for the media object rights owner further comprises
determining an expected revenue for an upcoming measurement period for each transaction structure in the set of potential sponsorship transaction structures; and
comparing the expected revenues; and
choosing, as a best owner transaction structure, the transaction structure in the set of potential transaction structures that maximizes expected revenue.

4. The method of claim 1, wherein the determining a best sponsor transaction structure and associated market value for the potential sponsor further comprises
inputting a set of sponsorship goals;
determining, from the set of sponsorship goals, an expected sponsor utility for an upcoming measurement period for each transaction structure in the set of potential sponsorship transaction structures; and
comparing the expected utilities; and
choosing, as a best sponsor transaction structure, the transaction structure in the set of potential transaction structures that maximizes expected utility.

5. The method of claim 1, wherein said combining said best owner and sponsor transaction structures into a composite transaction structure further comprises
estimating a current relative market power of the owner and sponsor; and
linearly combining the best owner transaction structure and the best sponsor transaction structure using the estimates of the current relative market power.

6. The method of claim 5, wherein said combining said best owner and sponsor transaction structures into a composite transaction structure further comprises
accessing one or more sponsorship requirements of the owner and/or the sponsor;
comparing the expected response to the sponsored media object with the requirements;
selectively enabling the sponsorship if the requirements are met;
optionally, scheduling a cut-off of sponsorship; and
optionally, scheduling a future financial transaction term determination.

7. A method of determining financial terms of a transaction related to associating a sponsored object with a media object on a network, the method comprising
receiving, from a remote host, a request for financial terms of a sponsorship transaction, wherein the request includes one or more attributes of a media object, a media object rights owner, a potential sponsor, a potential sponsored object, and one or more third parties;
analyzing sponsorship market activity to determine a set of potential sponsorship transaction structures;
analyzing media object and sponsored object response activity to determine expected consumer responses to the media object and the sponsored object;
determining a best owner transaction structure and associated market value for the media object rights owner;
determining a best sponsor transaction structure and associated market value for the sponsor;
determining a best third party transaction structure and associated market value for each third party in the one or more third parties;
combining said best transaction structures into a composite transaction structure with a fee schedule providing for remission of fees for one or more responses to the sponsored media object; and
transmitting, to the remote host, the composite transaction structure and fee schedule.

8. The method of claim 7, wherein the determining a best owner transaction structure and associated market value for the media object rights owner further comprises
determining an expected revenue for an upcoming measurement period for each transaction structure in the set of potential sponsorship transaction structures; and
comparing the expected revenues; and
choosing, as a best owner transaction structure, the transaction structure in the set of potential transaction structures that maximizes expected revenue.

9. The method of claim 7, wherein the determining a best sponsor transaction structure and associated market value for the potential sponsor further comprises
inputting a set of sponsorship goals;
determining, from the set of sponsorship goals, an expected sponsor utility for an upcoming measurement period for each transaction structure in the set of potential sponsorship transaction structures; and
comparing the expected utilities; and
choosing, as a best sponsor transaction structure, the transaction structure in the set of potential transaction structures that maximizes expected utility.

10. The method of claim 7, wherein the determining a third party transaction structure and associated market value for the third party further comprises
determining an expected revenue for an upcoming measurement period for each transaction structure in the set of potential sponsorship transaction structures; and
comparing the expected revenues; and
choosing, as a best third party transaction structure, the transaction structure in the set of potential transaction structures that maximizes expected revenue.

11. The method of claim 7, wherein said combining said best transaction structures into a composite transaction structure further comprises
estimating a current relative market power of the owner, sponsor and each third party in the one or more third parties; and
linearly combining the best transaction structures using the estimates of the current relative market power.

12. A method of determining time-varying financial terms of transactions related to associating a sponsored object with a media object on a network, the method comprising
receiving, from a remote host, a service request for an accounting update of a sponsorship transaction, wherein the request includes one or more attributes of a media object, a media object rights owner, a sponsor, and a sponsored object;
if the service request includes a billable consumer response to the sponsored media object, then combining said consumer response with previous consumer responses in accumulated responses for the current billing period;
if the request includes a scheduled pricing event, then
accessing accounting records for a concluded measurement period;
generating sponsorship billings for the concluded measurement period;
determining if there are remaining sponsorship goals unfulfilled in the concluded measurement period; and
if there are remaining sponsorship goals, invoking a sponsorship pricing process to determine transaction terms for a next measurement period.

13. The method of claim 12, wherein the combining said consumer response with previous consumer responses in accumulated responses for the current billing period further comprises
accessing one or more sponsorship limits;
comparing the accumulated responses to each of the sponsorship limits; and
if the accumulated responses exceed one or more of the sponsorship limits, ending sponsorship prematurely in the current measurement period.

14. The method of claim 12, wherein the determining if there are remaining sponsorship goals unfulfilled in the concluded measurement period further comprises
accessing accounting records for the sponsorship of the media object;
determining one or more sponsorship goals from the accounting records;
accumulating, from the accounting records, the total of billable consumer responses to the sponsored media object;
comparing the total of each consumer response in the billable consumer responses with one or more of the sponsorship goals;
if the number of billable consumer responses is short of a goal, determining that there is an unfulfilled sponsorship goal.

15. An apparatus to determining financial terms of a transaction related to associating a sponsored object with a media object on a network, the apparatus comprising
a memory, a computer central processing unit, and computer-executable instructions, said instructions operative to:
receive, from a remote host, a request for financial terms of a sponsorship transaction, wherein the request includes one or more attributes of a media object, a media object rights owner, a potential sponsor, and a potential sponsored object;
analyze sponsorship market activity to determine a set of potential sponsorship transaction structures;
analyze media object and sponsored object response activity to determine expected consumer responses to the media object and the sponsored object;
determine a best owner transaction structure and associated market value for the media object rights owner;
determine a best sponsor transaction structure and associated market value for the sponsor;
combine said best owner and sponsor transaction structures into a composite transaction structure with a fee schedule providing for remission of fees for one or more responses to the sponsored media object; and
transmit, to the remote host, the composite transaction structure and fee schedule.

16. The apparatus of claim 15, wherein the potential sponsorship transaction structures include two or more of the following seven structures:
(1) a payment per impression at a rate CPM, a payment per activation of a sponsored link at a rate CPC, and a payment per sponsored follow-on action at a rate CPA;
(2) a payment per impression at a rate CPM, and a payment per activation of a sponsored link at a rate CPC;
(3) a payment per impression at a rate CPM and a payment per sponsored follow-on action at a rate CPA;
(4) a payment per activation of a sponsored link at a rate CPC and a payment per sponsored follow-on action at a rate CPA;
(5) a payment per impression at a rate CPM;
(6) a payment per activation of a sponsored link at a rate CPC; and
(7) a payment per sponsored follow-on action at a rate CPA.

17. The apparatus of claim 15, wherein the operation to determine a best owner transaction structure and associated market value for the media object rights owner further comprises
computer executable instructions operative to:
determine an expected revenue for an upcoming measurement period for each transaction structure in the set of potential sponsorship transaction structures; and
compare the expected revenues; and
choose, as a best owner transaction structure, the transaction structure in the set of potential transaction structures that maximizes expected revenue.

18. The apparatus of claim 15, wherein the operation to determine a best sponsor transaction structure and associated market value for the potential sponsor further comprises computer executable instructions operative to:
input a set of sponsorship goals;
determine, from the set of sponsorship goals, an expected sponsor utility for an upcoming measurement period for each transaction structure in the set of potential sponsorship transaction structures; and
compare the expected utilities; and
choose, as a best sponsor transaction structure, the transaction structure in the set of potential transaction structures that maximizes expected utility.

19. The apparatus of claim 15, wherein said operation to combine said best owner and sponsor transaction structures into a composite transaction structure further comprises computer executable instructions operative to:
estimate a current relative market power of the owner and sponsor; and
linearly combine the best owner transaction structure and the best sponsor transaction structure using the estimates of the current relative market power.

20. An apparatus to determine time-varying financial terms of transactions related to associating a sponsored object with a media object on a network, the apparatus comprising
a memory, a computer central processing unit, and computer-executable instructions, said instructions operative to:
receiving, from a remote host, a service request for an accounting update of a sponsorship transaction, wherein the request includes one or more attributes of a media object, a media object rights owner, a sponsor, and a sponsored object;
if the service request includes a billable consumer response to the sponsored media object, then combining said consumer response with previous consumer responses in accumulated responses for the current billing period;
if the request includes a scheduled pricing event, then
accessing accounting records for a concluded measurement period;
generating sponsorship billings for the concluded measurement period;
determining if there are remaining sponsorship goals unfulfilled in the concluded measurement period; and
if there are remaining sponsorship goals, invoking a sponsorship pricing process to determine transaction terms for a next measurement period.
